(19) United States
(12) Patent Application Publication
(10) Pub. No.: US 2025/0348335 A1
(43) Pub. Date: Nov. 13, 2025

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YASUNORI SHIMAKAWA, Chiba (JP)

(21) Appl. No.: 19/192,483

(22) Filed: Apr. 29, 2025

(30) Foreign Application Priority Data
May 8, 2024 (JP) 2024-076090

(51) Int. Cl. G06F 9/451; G06T 11/00

(52) U.S. Cl. CPC G06F 9/451; G06T 11/001; G06T 2200/24

(57) ABSTRACT

The present disclosure is direct to an information processing apparatus acquires, from a server, an application group corresponding to an available service; determines whether or not the acquired application group includes a package including a plurality of applications; and generates an operation screen on which operation icons respectively corresponding to the plurality of applications are collectively arranged for each package in a case where the application group includes the package in accordance with a result of the determining.

### BACKGROUND OF THE INVENTION

### Field of the Invention

The present invention relates to an information processing apparatus, a control method, and a storage medium.

### Description of the Related Art

In an image forming apparatus having a network function, various services such as abnormality analysis and a charging system are developed by transmitting device information and a use history of a user to a management server. For example, a service in which management of consumables such as ink is performed by the management server and automatic delivery is performed when the remaining amount decreases is also an example thereof. In recent years, with the introduction of a subscription contract, a service for renting a device body and consumables to a user who subscribes to the service and performing fixed-rate provision without incurring initial investment or maintenance cost has also been widespread.

Some image forming apparatuses provide a platform for function addition, and allow a new function to be added by installing an application program (hereinafter, simply called an application) operating on the platform. Japanese Patent Laid-Open No. 2012-27662 proposes a technique of determining an icon of an installed application from icon arrangement information of a standard app and arranging the icon on an app list screen.

However, the above-described known technique has the following problems. When a packaged app set (app group) is installed, in the above-described known technology, those apps are arranged in a place where no standard app is arranged on the app list screen, and there is a possibility that the arrangement positions are dispersed in some cases. For example, when a packaged application group is installed as it is, the icons of the installed app set are arranged as they are so as to continue from the icon arrangement of the app list screen before installation. Such icon arrangement makes it difficult to discriminate combinations of apps included in packaging. When common apps arranged for each packaging are put together as a common one, it is necessary to select a packaging setting after app activation. When icons having the same name or the same icon and being set for packaging are arranged, the user needs to confirm which icon to have been set for packaging. While the name of the icon can be the name of the packaging at the time of installation for easily discriminating which package the icon belongs to, it is necessary to assign the packaging name with a limited number of characters, and there has been a case where a character string indicating the function cannot be included. In such a case, the user needs to discriminate the function only by the icon, which is troublesome.

### SUMMARY OF THE INVENTION

The present invention enables realization of a mechanism for appropriately arranging an installed application on a predetermined screen when installing a plurality of packaged applications.

One aspect of the present invention provides an information processing apparatus comprising: one or more memory devices that store a set of instructions; and one or more processors that execute the set of instructions to: acquire, from a server, an application group corresponding to an available service; determine whether or not the acquired application group includes a package including a plurality of applications; and generate an operation screen on which operation icons respectively corresponding to the plurality of applications are collectively arranged for each package in a case where the application group includes the package in accordance with a result of the determining.

Another aspect of the present invention provides a control method for an information processing apparatus, the control method comprising: acquiring, from a server, an application group corresponding to an available service; determining whether or not the acquired application group includes a package including a plurality of applications; and generating an operation screen on which operation icons respectively corresponding to the plurality of applications are collectively arranged for each package in a case where the application group includes the package in accordance with a result of the determining.

Still another aspect of the present invention provides a non-transitory computer-readable storage medium storing a computer program for causing a computer to execute each process in a control method for an information processing apparatus, the control method comprising: acquiring, from a server, an application group corresponding to an available service; determining whether or not the acquired application group includes a package including a plurality of applications; and generating an operation screen on which operation icons respectively corresponding to the plurality of applications are collectively arranged for each package in a case where the application group includes the package in accordance with a result of the determining.

Further features of the present invention will be apparent from the following description of exemplary embodiments with reference to the attached drawings.

### BRIEF DESCRIPTION OF THE DRAWINGS

FIG. 1 is a drawing illustrating an overall configuration of a system according to an embodiment.

FIG. 2 is a block diagram illustrating a schematic configuration of hardware of an image forming apparatus 100 according to the embodiment.

FIG. 3 is a drawing illustrating an operation unit 116 of the image forming apparatus 100 according to the embodiment.

FIG. 4 is a block diagram illustrating a schematic configuration of hardware of a device management server 200 according to the embodiment.

FIG. 5 is a block diagram illustrating a schematic configuration of hardware of a service management server 300 according to the embodiment.

FIG. 6 is a block diagram illustrating a schematic configuration of hardware of an app management server 400 according to the embodiment.

FIG. 7 is a table showing an association among a contract form, a function, and app availability according to the embodiment.

FIG. 8 is an overall sequence diagram according to the embodiment.

FIG. 9 is a flowchart showing an app package installation process according to the embodiment.

FIG. 10 is a flowchart showing an operation icon arrangement process according to the embodiment.

FIG. 11 is a flowchart showing the operation icon arrangement process according to the embodiment.

FIGS. 12A and 12B are drawings illustrating an example of operation icon arrangement according to the embodiment.

FIGS. 13A to 13C are drawings illustrating an example of operation icon arrangement according to the embodiment.

FIGS. 14A to 14C are drawings illustrating an example of operation icon arrangement according to the embodiment.

FIG. 15 is a drawing illustrating an example of an arrangement in which all common apps are integrated by operation icons.

FIGS. 16A and 16B are drawings illustrating an example of icon arrangement when an app according to the embodiment is installed alone.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### System Arrangement

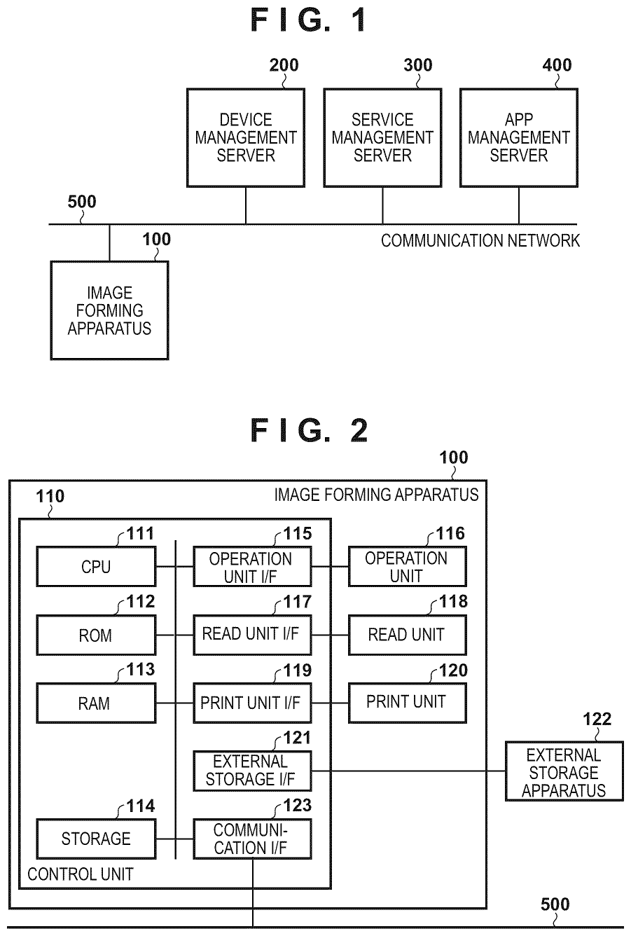

A first embodiment of the present invention will be explained below. An overall configuration example of a system according to the present embodiment will be described with reference to FIG. 1. In the present system, the image forming apparatus 100 as an information processing apparatus, the device management server 200, the service management server 300, and the app management server 400 are connected via a network 500 such as the Internet. Here, for ease of description, only the image forming apparatus 100 is taken as an example of the image forming apparatus connected to the network 500, but a plurality of other image forming apparatuses are to be connected. An image forming apparatus will be described as an example of the information processing apparatus according to the present invention, but the present invention is not intended to be limited, and any device may be used as long as an arbitrary application is installed. For example, it may be a personal computer, an information processing terminal, a tablet, a smartphone, a wearable device, or the like.

The image forming apparatus 100 is an example of an information processing apparatus, records contract information into a storage 114 of the image forming apparatus 100 described later, and controls the image forming apparatus 100 in accordance with the recorded contract information. The contract information includes license information of the application. Details of the contract information and details of control of the image forming apparatus 100 performed in accordance with the contract information will be described later. The image forming apparatus 100 can receive the contract information by communicating with the device management server 200 via the network 500.

The device management server 200 holds the contract information notified from the service management server 300 and provides the image forming apparatus 100 with the contract information. The service management server 300 is a server that manages services that can be provided by the image forming apparatus connected to the network 500. The app management server 400 is a server that manages applications installed in the image forming apparatus connected to the network 500.

Communication between the image forming apparatus 100 and the device management server 200, the service management server 300, and the app management server 400 uses a communication protocol such as Hypertext Transfer Protocol (hereinafter, called HTTP). A known method is used as a control method for the communication protocol. The device management server 200 is configured to relay between the image forming apparatus 100 and the service management server 300, but the present embodiment is not limited to this. For example, the image forming apparatus 100 and the service management server 300 may be configured to directly transfer contract information via the Internet.

### Configuration of Image Forming Apparatus

The configuration of the image forming apparatus 100 according to the present embodiment will be described with reference to FIG. 2. The image forming apparatus 100 includes a control unit 110, the operation unit 116, a read unit 118, and a print unit 120. The control unit 110 includes a CPU 111, a ROM 112, a RAM 113, the storage 114, an operation unit interface (I/F) 115, a read unit I/F 117, a print unit I/F 119, an external storage I/F 121, and a communication I/F 123. CPU is an abbreviation for central processing unit. ROM is an abbreviation for read only memory. RAM is an abbreviation for random access memory.

The CPU 111 controls the operation of the image forming apparatus 100. The CPU 111 reads a program stored in the ROM 112 or the storage 114 into the RAM 113 and executes the program. The program is, for example, a control program, and the CPU 111 performs various controls such as read control and print control by executing the control program. The ROM 112 stores a program executed by the CPU 111. The ROM 112 also stores a boot program, font data, and the like. The RAM 113 is a main storage memory of the CPU 111. The RAM 113 is used as a work area of the CPU 111 and a temporary storage area for developing programs stored in the ROM 112 and the storage 114. The RAM 113 is also used to temporarily store image data.

The storage 114 stores image data, print data, an address book, shortcuts, various programs, and various setting information. In the present embodiment, a flash memory is assumed as the storage 114, but an auxiliary storage apparatus such as an SSD, an HDD, or an eMMC may be used. SSD is an abbreviation for solid state drive. HDD is an abbreviation for hard disk drive. eMMC is an abbreviation for embedded multi media card.

The operation unit I/F 115 connects the operation unit 116 and the control unit 110. The operation unit 116 includes physical keys and a touch panel. The touch panel is configured in an integrated manner with a touch panel sheet being attached to a display. The operation unit 116 receives an operation from the user with physical keys or displays a screen via a touch panel.

The read unit I/F 117 connects the read unit 118 and the control unit 110. The read unit 118 reads an image of a document and generates image data. The image data generated by the read unit 118 is used for executing a character recognition process, being transmitted to an external apparatus, or be printed on a printing sheet.

The print unit I/F 119 connects the print unit 120 and the control unit 110. The CPU 111 transfers the image data of a print target to the print unit 120 via the print unit I/F 119. The print unit 120 prints an image onto a sheet fed from a sheet feed cassette. The method for printing an image may be an electrophotographic method for printing an image using toner, or an inkjet method for printing an image using ink.

The external storage I/F 121 connects an external storage apparatus 122 and the control unit 110. The CPU 111 stores image data in the external storage apparatus 122 via the external storage I/F 121. The present embodiment assumes a USB interface as the external storage I/F 121, and a USB memory as the external storage apparatus 122. However, the present invention is not intended to be limited, and an SD card or the like may be used as the external storage apparatus 122.

The control unit 110 is connected to the network 500 by the communication I/F 123. The network 500 is, for example, a LAN. LAN is an abbreviation for local area network. The communication I/F 123 controls transmission and reception of data performed via the network 500. For example, the communication I/F 123 of the image forming apparatus 100 is connected to an external apparatus via a USB or a network. That is, the communication I/F 123 is connected to the USB or the network to communicate with the external apparatus. In the present embodiment, using the communication I/F 123, the image forming apparatus 100 communicates with the device management server 200, the service management server 300, and the app management server 400 via the network 500.

### Operation Unit

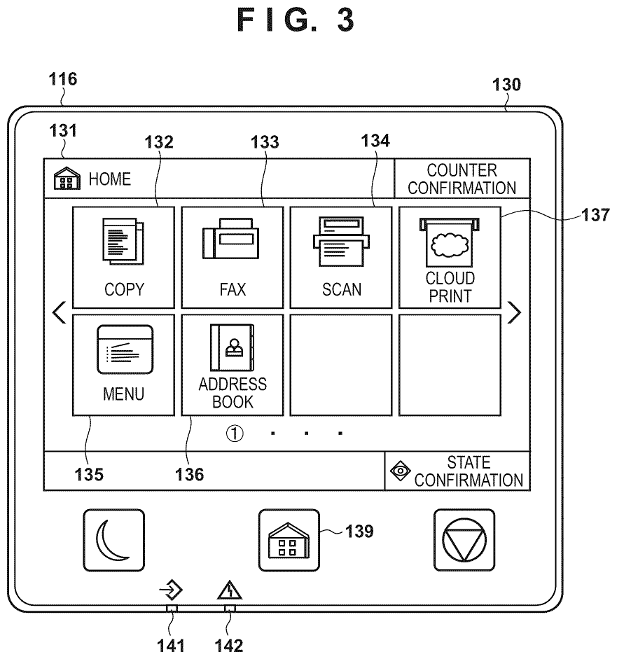

A configuration example of the operation unit 116 according to the present embodiment will be described with reference to FIG. 3. The operation unit 116 includes a touch panel 130, a Data LED 141, and an Error LED 142. The touch panel 130 illustrated in FIG. 3 displays a home screen (operation screen) 131 displayed immediately after activation of the image forming apparatus 100.

The home screen 131 is a screen for instructing execution of each function of the image forming apparatus 100. The home screen 131 illustrated in FIG. 3 is a default home screen before an additional application is installed. The home screen 131 selectively displays a copy button 132, a fax button 133, a scan button 134, a menu button 135, an address book button 136, and a cloud print button 137.

The copy button 132 is a button for using a copy function in which the print unit 120 prints an image based on image data generated by reading a document by the read unit 118. The fax button 133 is a button for using a fax function for transmitting, using a modem (not illustrated), image data generated by reading a document by the read unit 118. The scan button 134 is a button for using a transmission function of transmitting, via the communication unit I/F 123, image data generated by reading a document by the read unit 118. Note that the transmission function includes an electronic mail function of transmitting image data attached to an electronic mail, and a folder transmission function of transmitting image data to be stored in a designated folder. The menu button 135 is a button for transitioning to various function menus, and the address book button 136 is a button for calling and displaying a registered address book. The cloud print button 137 is a button for performing image print from an online storage server (not illustrated).

A home key 139 is an electrostatic touch key, and is a button for switching a displayed screen to the home screen. By being turned on during data transmission, the Data LED 141 notifies the user that the image forming apparatus 100 is transmitting data. The Error LED 142 is turned on when any error occurs in the image forming apparatus 100.

### Configuration of Server Apparatus

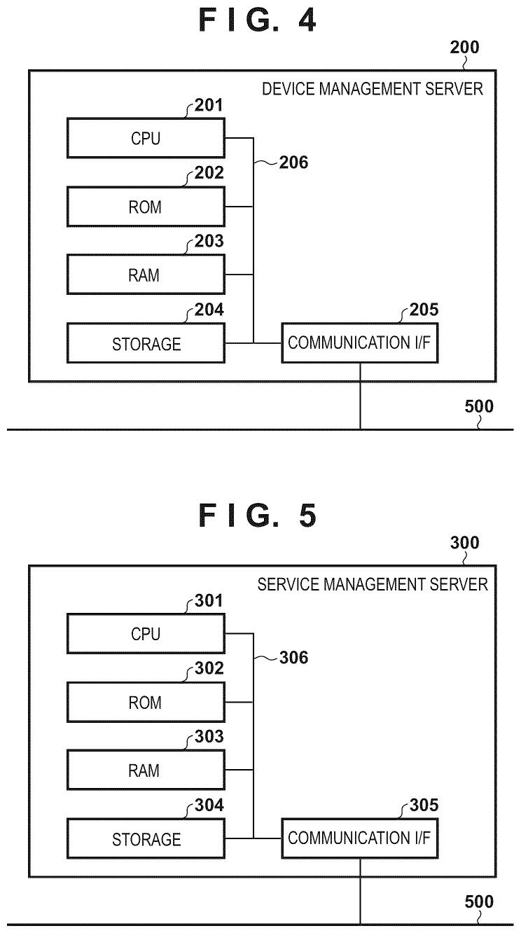

The configurations of various server apparatuses will be described with reference to FIGS. 4 to 6. FIG. 4 illustrates a schematic configuration of hardware of the device management server 200. The device management server 200 includes a CPU 201, a ROM 202, a RAM 203, a storage 204, and a communication I/F 205. The modules are connected in such a manner that data can be exchanged with one another via a system bus 206.

The CPU 201 performs processes such as calculation, determination, and control of data and commands in accordance with software stored in the ROM 202, the RAM 203, or the storage 204. The RAM 203 is used as a temporary storage area when the CPU 201 performs various processes. The storage 204 records an operating system (OS), application software, programs, and the like. Device information for each image forming apparatus described later and a record table of a contract status of each service are also recorded in the storage 204. The communication I/F 205 uses a wireless LAN or a wired LAN corresponding to a standard such as IEEE802.11a, and exchanges data with equipment on the same network or the Internet using a protocol such as TCP/IP.

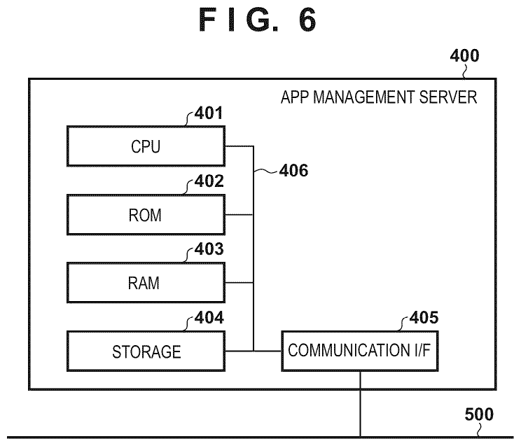

FIG. 5 illustrates a schematic configuration of hardware of the service management server 300. Similarly to FIG. 4, a CPU 301 includes a ROM 302, a RAM 303, a hard disk 304, and a communication I/F 305, and the modules are connected in such a manner that data can be exchanged with one another via a system bus 306. Since the modules are similar to the corresponding configurations in FIG. 4, the description thereof is omitted. FIG. 6 illustrates a schematic configuration of hardware of the app management server 400. Similarly to FIG. 4, a CPU 401 includes a ROM 402, a RAM 403, a hard disk 404, and a communication I/F 405, and the modules are connected in such a manner that data can be exchanged with one another via a system bus 406. Since the modules are similar to the corresponding configurations in FIG. 4, the description thereof is omitted.

Note that the present invention is not limited to the configurations of the various server apparatuses illustrated in FIGS. 4 to 6. The present invention may have a configuration of implementing at least one service that can be provided by the device management server 200, the service management server 300, and the app management server 400 using a server on the cloud. Each of the device management server 200, the service management server 300, and the app management server 400 does not need to be configured by one server. That is, the functions provided by the device management server 200, the service management server 300, and the app management server 400 may be implemented by a server system including a plurality of servers of three or more or one server in which all the servers are aggregated.

### Services

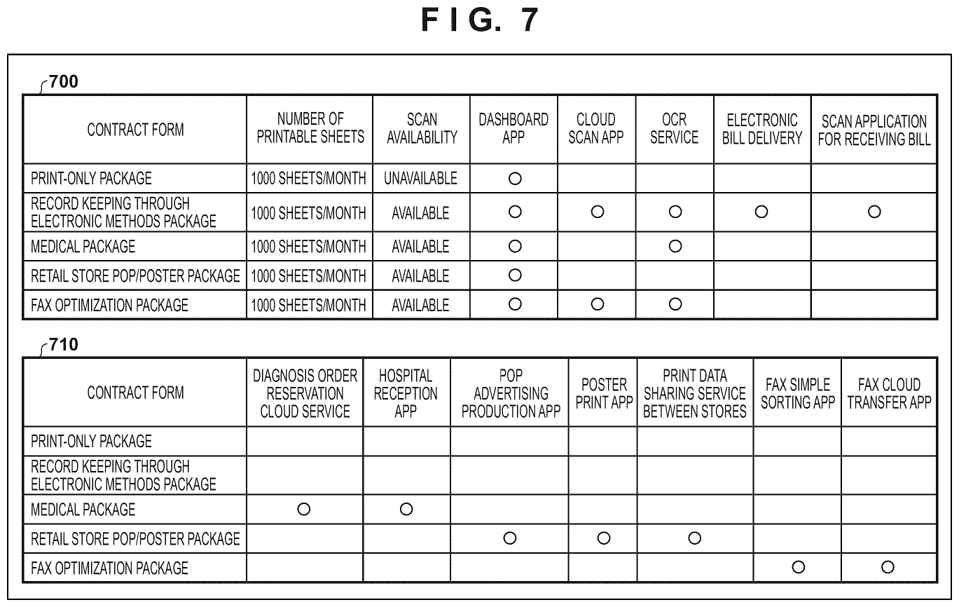

The services that can be provided by the image forming apparatus 100 according to the present embodiment will be described with reference to FIG. 7. The services provided by the image forming apparatus 100 can be provided by the user who uses the image forming apparatus 100 making a service contract. Examples of service contract include contracts in which a plurality of apps (services) are packaged, such as a print-only package, a Law on Book and Record Keeping through Electronic Methods package, a medical package, a retail store POP/poster package, and a FAX optimization package. The plurality of packaged applications can be installed collectively by one installer.

As illustrated in FIG. 7, the service packages each have different availability of the functions shown in Tables 700 and 710. Each of the service packages allows 1000 sheets to be printed per month, but scanning cannot be executed with the print-only package. The scan function can be used except for the print-only package, but only an application permitted to be used in each package can be installed and used. A dashboard app that manages the service contract is effectively installed in any contract. In each of the service packages, the applications marked with “o” in Tables 700 and 710 are packaged.

### Sequence

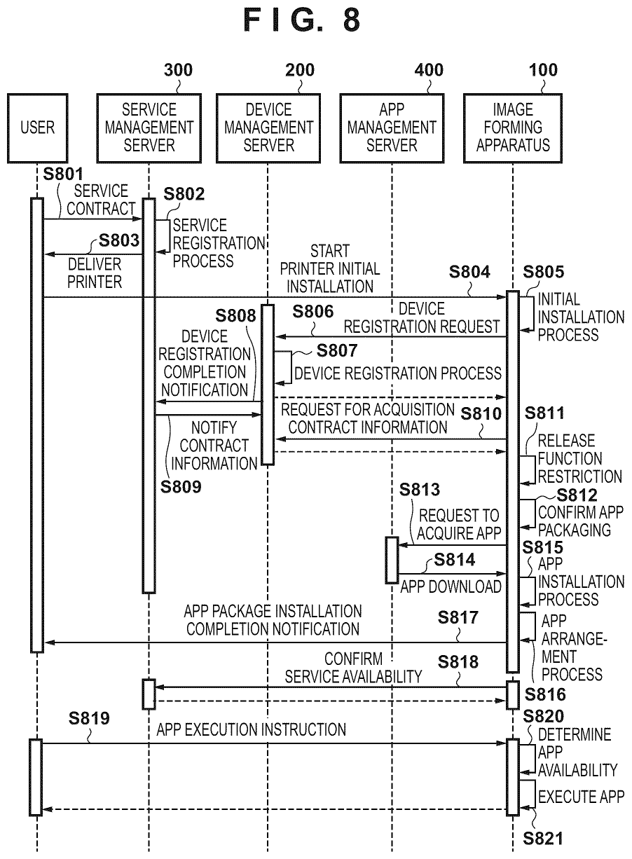

With reference to FIG. 8, a sequence from performing device registration of the image forming apparatus from the service contract according to the present embodiment, granting license, up to installing an application will be described. A number following “S” indicates a step number in the sequence.

In S801, the service management server 300 receives a service contract from the user. Upon receiving a request for service contract from the user, the service management server 300 performs in S802 a service registration process of associating the user information, the service content, and the image forming apparatus to be registered. When the service registration process selected by the user from among the various services illustrated in FIG. 7 is completed, the image forming apparatus 100 registered in S802 is delivered to the user in S803.

The user who has received the image forming apparatus 100 unpacks and installs the image forming apparatus 100, and activation is performed. Upon activation, in S804, the image forming apparatus 100 starts an initial installation process in response to a user's instruction. In step S805, the image forming apparatus 100 executes the initial installation process in accordance with a user's instruction, and performs an initial setting such as network setting for connection to the Internet. Upon completing the network connection in the initial setting in S806, the image forming apparatus 100 performs communication of a device registration request together with identification information such as a product serial number of the image forming apparatus to the device management server 200.

The device management server 200 having received the device registration request executes a registration process based on the identification information received from the image forming apparatus 100 in S807. Upon completing the registration process, the device management server 200 in S808 returns the registration result to the image forming apparatus 100 and makes a device registration completion notification to the service management server 300. This device registration completion notification to the service management server 300 may be performed to a plurality of service management servers 300 for each service.

Upon receiving the device registration completion notification from the device management server 200, the service management server 300 notifies the device management server 200 of the contract information of the associated service based on the identification information of the image forming apparatus 100 received at that time in S809. In the present embodiment, the contract information includes information related to a contract including information for discriminating that the contract has been concluded for use in activation at the time of initial setting of the apparatus. Furthermore, the contract information includes application information included in the packaging associated with the service content and a license of the package. The device management server 200 holds the contract information notified from the service management server 300 into the device management server 200.

Thereafter, in S810, the image forming apparatus 100 makes a request to the device management server 200 to acquire the contract information, and receives, as an HTTP response, the contract information of each service held in the device management server 200. The acquisition of the contract information is a request for collectively acquiring the contract states of a plurality of services, and is not communication performed for each service. The image forming apparatus 100 having received the contract information of the plurality of services from the device management server 200 stores the contract information of each service in the storage 114 in S811, and reflects the contract information such that control in accordance with the contract information is performed in the subsequent processing by the image forming apparatuses. The reflection here includes releasing the function of the image forming apparatus related to the service that has been restricted so far when the service having been contracted can be confirmed, for example. In the present embodiment, the image forming apparatus 100 is provided on the assumption that the user has contracted the service, and all the basic functions such as the print function, the scan function, and the copy function of the image forming apparatus 100 are restricted until it is confirmed in S811 that the contract has been made. Then, in and after S811, these functions become available in accordance with the contract.

In addition to release of the functional restriction in accordance with the contract information, the image forming apparatus 100 also performs an installation process of the applications included in the package of the contracted service. Upon confirming in S812 that the service has been contracted from the contract information, the image forming apparatus 100 confirms, from the contract information, the packaging of the applications related to the service and the license of the package. Upon confirming that the packaging and the license thereof are present the image forming apparatus 100, in S813, makes a download request for the applications included in the packaging together with the license of the package to be transmitted to the app management server 400.

The app management server 400 having received the download request for the application confirms the license acquired from the image forming apparatus 100 in S814. If there is no problem, the app management server 400 downloads the application to the image forming apparatus 100 in S814. Subsequently, in S815, upon completing the download of the application, the image forming apparatus 100 performs installation.

Upon completing the installation, the image forming apparatus 100 performs in S816 an arrangement process onto the operation screen of the applications included in the packaging. Upon completing the app package installation in S817, the image forming apparatus 100 notifies the operation unit 116 of package installation completion and completes the installation process. Details of the arrangement process of the applications onto the operation screen will be described later. Thereafter, in S818, the image forming apparatus 100 periodically acquires data for confirming the validity period of the service and the presence or absence of the license from the service management server 300.

Then, upon receiving an app execution instruction from the user in S819, the image forming apparatus 100 confirms the presence or absence of the license of the corresponding app and the validity period of the service from the information on the app operated in S820. If the license is present and it is within the validity period, the image forming apparatus 100 executes the app in S821, displays the result on the operation unit 116, and ends the present sequence.

### Installation Process of App Package

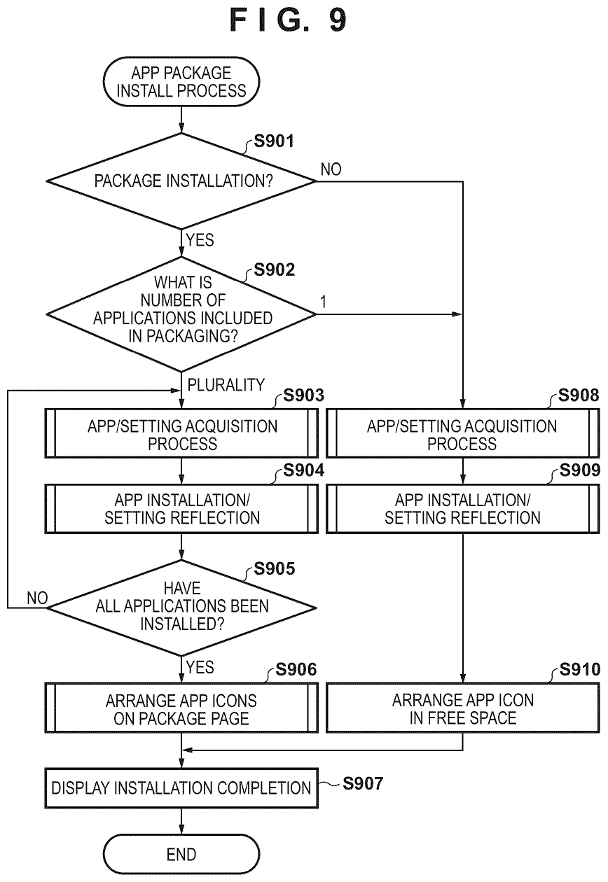

A process procedure of license confirmation, app download, installation, and the arrangement process on the operation screen from S812 to S816 of FIG. 8 will be described with reference to FIG. 9. The process described below is implemented, for example, by the CPU 111 of the image forming apparatus 100 reading, into the RAM 113, a program stored in the ROM 112 or the storage 114 and executing the program.

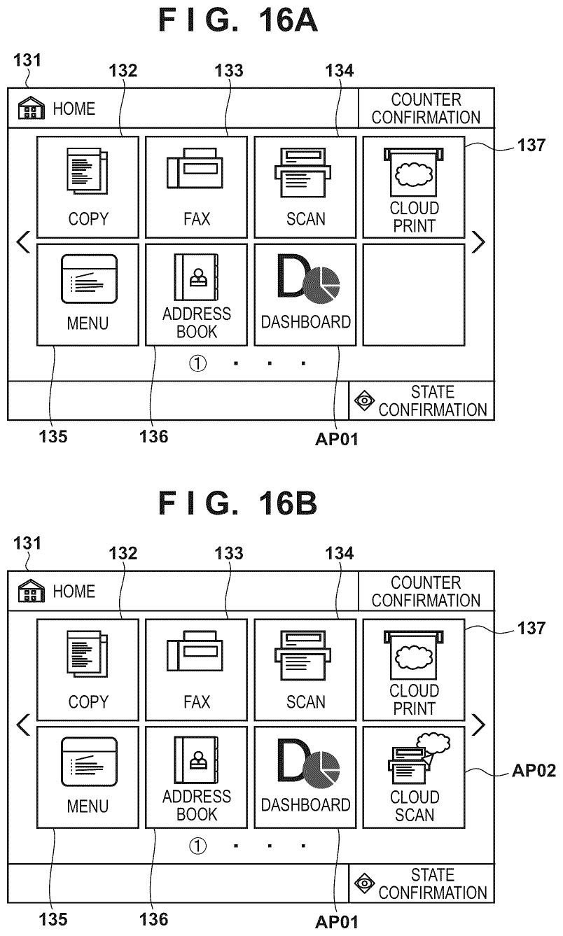

In S901, the CPU 111 confirms whether or not to perform package installation. The process proceeds to S908 if package installation is not to be performed, and the process proceeds to S902 if package installation is to be performed. In S908, the CPU 111 downloads the target app and setting from the app management server 400, installs the app downloaded in S909, and reflects the setting. Thereafter, in S910, as illustrated in FIGS. 16A and B, the CPU 111 sequentially arranges the operation icons of the app in a free space where no other icons are arranged, and the process proceeds to S907. In FIG. 16A, a dashboard app is added to the free space, and in FIG. 16B, cloud scan is added to the free space.

On the other hand, in S902, the CPU 111 confirms the number of applications included in the packaging in the case of package installation. If one applications is included in the packaging, it is determined that package installation is not to be performed, and the processes of S908 to S910 are executed similarly to the case of not performing package installation. If a plurality of applications are included in the packaging, the process proceeds to S903, and the CPU 111 downloads the apps and the settings in the package from the app management server 400. Subsequently, in S904, the CPU 111 installs the apps of the package having been downloaded and reflects the setting. If the package is downloaded, an installer for each package is downloaded, and a plurality of apps can be collectively installed by the installer. In S905, the CPU 111 determines whether or not all the applications included in the packaging have been installed. The process returns to S903 if all the applications included in the packaging have not been installed, and the process proceeds to S906 if all the applications have been installed.

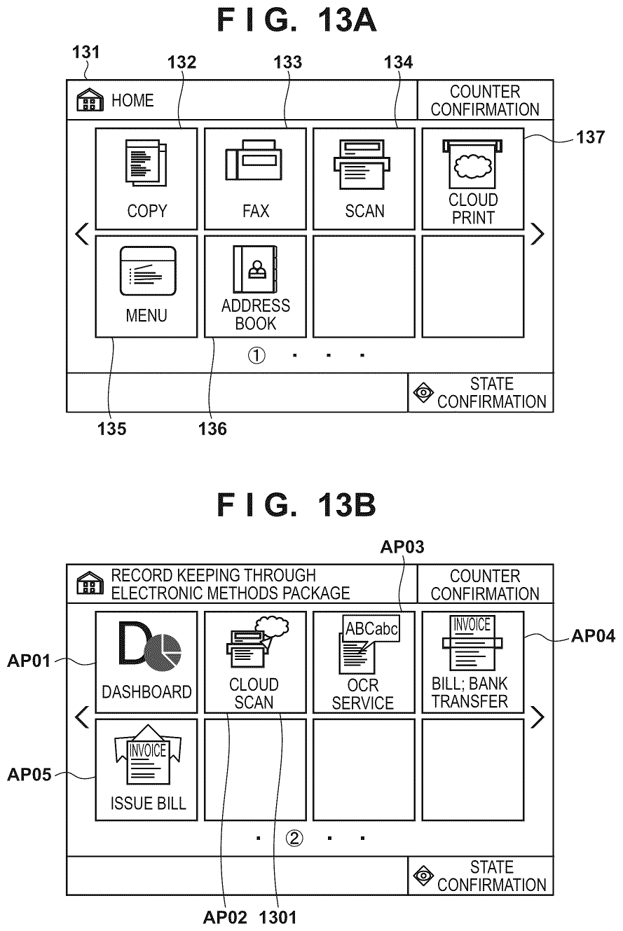

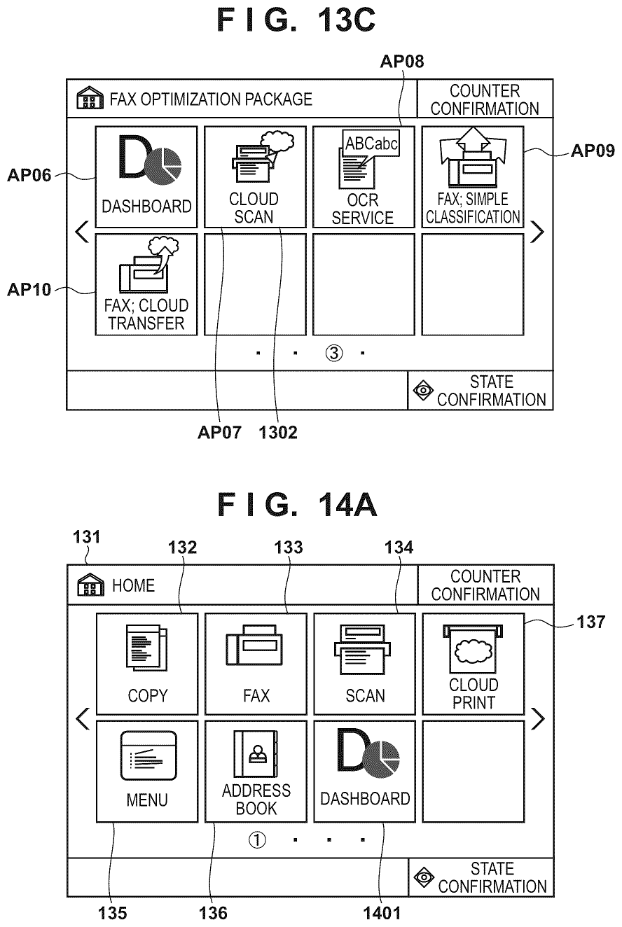

In S906, the CPU 111 performs a process of arranging, on the package page, the operation icons illustrated in FIGS. 13B and 13C. Upon completing the arrangement of the operation icons, the process proceeds to S907, and the CPU 111 notifies the user of the installation completion and ends the process of the present flowchart.

### Icon Arrangement Process at Package Installation

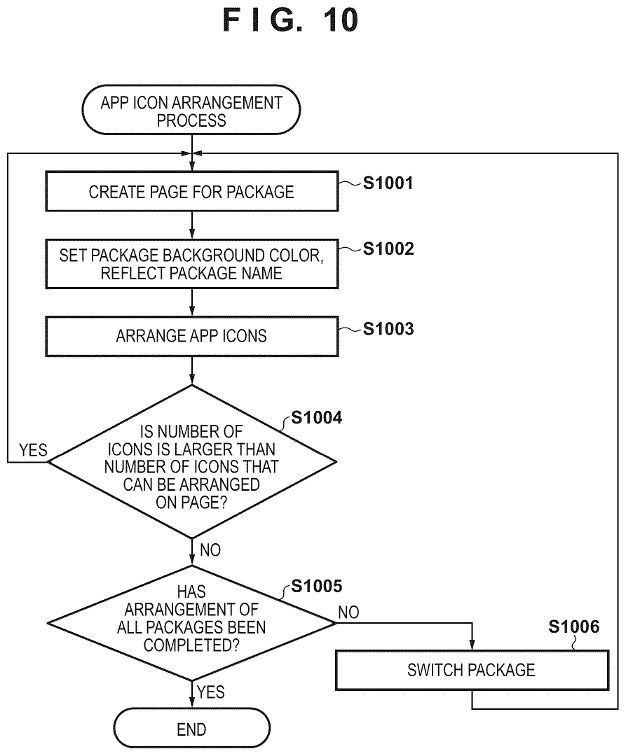

A detailed process procedure of the arrangement of the operation icons at the time of package installation (S906) according to the present embodiment will be described with reference to FIG. 10. The process described below is implemented, for example, by the CPU 111 of the image forming apparatus 100 reading, into the RAM 113, a program stored in the ROM 112 or the storage 114 and executing the program.

In S1001, the CPU 111 creates a page on which icons of the applications included in the package are arranged. For example, a page (different screen) different from the page on which the default applications illustrated in FIG. 13A are arranged is created. In S1002, the CPU 111 reflects, to the page, the background color set in the package, and in addition, reflects the package name so as to be displayed at a predetermined position. In S1003, the CPU 111 arranges a plurality of applications installed in a predetermined arrangement in the created page. For example, as illustrated in FIG. 13B, when the “Law on Book and Record Keeping through Electronic Methods package” is installed, a page for the package is created, and icons corresponding to apps AP01 to AP05 included in the package are sequentially arranged. By arranging the icon for each package for each page in this manner, it is possible to provide a more user-friendly operation system. Note that although an example of sequentially displaying a plurality of pages on the operation screen is illustrated here, the present invention is not limited, and for example, a plurality of tabs or folders may be provided, and an icon may be arranged for each tab or each folder.

In S1004, the CPU 111 determines whether or not the maximum number of icons that can be arranged on the page has been exceeded. If the number of icons exceeds the maximum number, the process returns to S1001, a page is added, and remaining icons are arranged, and otherwise, the process proceeds to S1005. In S1005, the CPU 111 determines whether or not the arrangement of all the installed packages has been completed. If not completed, the process proceeds to S1006, and the CPU 111 switches the package and returns the process to S1001. If an additional package is installed, for example, as illustrated in FIG. 13C, an additional page (“FAX optimization package”) is created, and icons corresponding to apps AP06 to AP10 included in the package are sequentially arranged. On the other hand, if the arrangement of all the installed packages has been completed, the process of the present flowchart ends.

### Operation Screen

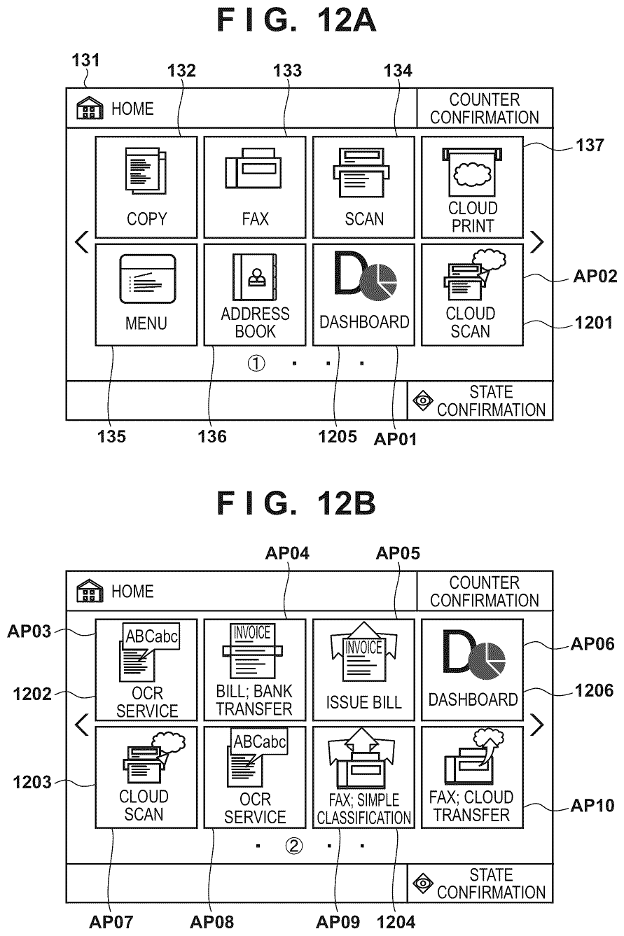

The arrangement of the operation icons on the operation screen of the image forming apparatus 100 according to the present embodiment will be described with reference to FIGS. 12A and B and FIGS. 13A to C. AP01 and AP06 are dashboard apps for performing of setting of app packages and subscription management. The cloud scan apps AP02 and AP07 are cloud scan apps that read documents set in the read unit 118 of the image forming apparatus 100 with predetermined settings and save the documents in the folder of the server having been designated.

For example, when cloud scan of the Law on Book and Record Keeping through Electronic Methods package is executed, scanning is performed with settings such as resolution in accordance with the Law on Book and Record Keeping through Electronic Methods. Furthermore, image data obtained by the scanning is saved in a receipt and bill management server (not illustrated) from the communication I/F 123 via the network 500. On the other hand, when cloud scan of the FAX optimization package is executed, image data obtained by the scanning with the set resolution is saved in a FAX transmission server (not illustrated) from the communication I/F 123 via the network 500. Furthermore, the saved image data is transmitted to a set transmission destination via a FAX line. Thus, even in the same app, the process may be different depending on a package-dedicated setting for each package. In such a case, when the operation icons are put together for each package, the user can easily select an icon of a desired package, and an improved user interface can be provided.

AP03 and AP08 are OCR service apps that scan documents set in the image forming apparatus 100, perform OCR processing, and convert from a scanned image into character data. AP04 is a bill bank transfer app that acquires, from character data subjected to OCR processing, a transfer destination and an amount billed included in the bill set in the read unit 118 of the image forming apparatus 100, and performs a transfer process to the designated transfer destination. AP05 is a bill issuance app that prints, together with an envelope for delivery, bill data saved in a designated folder. AP09 is a FAX sorting app that stores received FAX documents into a designated folder in accordance with predetermined settings. AP10 is a FAX cloud transfer app that transfers received FAX documents to a folder of a cloud for which subscription is contracted.

In a case of being installed for each app, as illustrated in FIGS. 12A and B, there are cloud scan 1201 of the Law on Book and Record Keeping through Electronic Methods package and cloud scan 1203 of the FAX optimization package, and since each operates with a different setting, rearrangement is required. Similarly, OCR services 1202 and 1204 are arranged on the same screen, and it is difficult to discriminate which package the app is related to.

On the other hand, in the case of installing for each package according to the present embodiment, the operation icons are put together on different pages for each package of the Law on Book and Record Keeping through Electronic Methods package illustrated in FIG. 13B and the FAX optimization package illustrated in FIG. 13C. In other words, according to the present embodiment, operation icons for each package are grouped and arranged. The grouped operation icons are respectively arranged on different screens. Here, the different screens are managed by, for example, pages, tabs, or folders. In this manner, in the case of installing for each package and arranging icons on a predetermined page in accordance with the package, even if icons of the apps having the same name are arranged, it is possible to easily discriminate which package the app is related to. For example, cloud scan 1301 of the icon Law on Book and Record Keeping through Electronic Methods package and cloud scan 1302 of the FAX optimization package are arranged on different pages for each package, and therefore they can be easily discriminated. It is possible to easily confirm which package another app is associated with.

Since the icons are arranged for each package, it is possible to collectively delete each corresponding page in a case of deleting the package. Note that an icon may be restricted from moving from the page for each package. This can suppress the icon of the package from moving to another page, tab, folder, or the like. Alternatively, when an icon of the package is moved to another page or the like, a copy may be generated and the generated icon may be moved. This can maintain as it is the icons arranged on the original different screens. Control may be performed such that an app not to be deleted at the time of uninstallation of the package can be designated by the user. In order to easily distinguish pages, folders, tabs, and the like related to the package, the background and the like may be displayed in dedicated colors.

As described above, the information processing apparatus according to the present embodiment acquires, from the server, an application group corresponding to an available service, and determines whether or not the acquired application group includes a package including a plurality of applications. The present information processing apparatus generates an operation screen on which operation icons respectively corresponding to the plurality of applications are collectively arranged (grouped) for each package in a case where the application group includes the package in accordance with a result of the determining. Thus, by arranging icons of apps on different screens generated for each package, the present information processing apparatus can cause the user to easily recognize the apps included in each package. By displaying the package name on a part of the different screens, the user can easily understand the app and setting of which package to be reflected. By changing the background color of the different screens from that of the default screen, it is easy to determine which package the screen is of. In the screen example of the present case, up to eight operation icons can be arranged. However, in a case where the package includes more than the maximum number of apps that can be arranged, the user can easily understand that the packages are the same by adding pages with the same settings and arranging icons of the apps exceeding the maximum number. According to the present embodiment, since the application icons after installation are put together for each package, it is no longer necessary to confirm and rearrange the apps included in the package after installation, and it is easy to cooperatively operate the apps.

### Second Embodiment

Hereinafter, a second embodiment of the present invention will be described. In the first embodiment, a form in which all the apps included in the package are installed for each package has been described. In the present embodiment, a form in which the same apps are installed as a common app among a plurality of packages will be described.

### Icon Arrangement Process at Package Installation

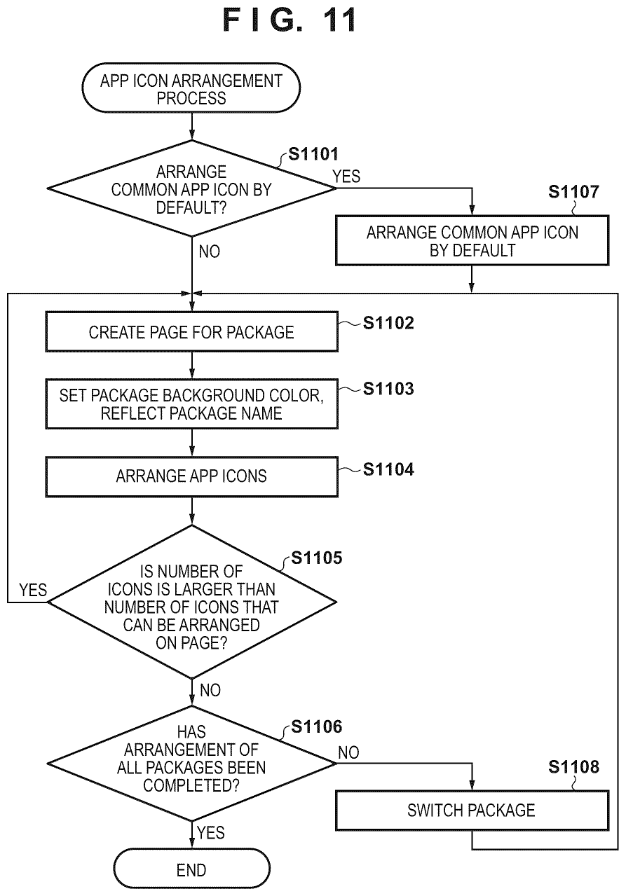

A detailed process procedure of the arrangement of the operation icons at the time of package installation (S906) according to the present embodiment will be described with reference to FIG. 11. The process described below is implemented, for example, by the CPU 111 of the image forming apparatus 100 reading, into the RAM 113, a program stored in the ROM 112 or the storage 114 and executing the program.

In S1101, the CPU 111 determines whether or not to arrange the common app by default. If arranging, the process proceeds to S1107, and the CPU 111 arranges the icon of the common app at a position having a free space on the default home screen, and the process proceeds to S1102. If not arranging or if the app is not the common app, the process proceeds to S1102. Since the subsequent process is similar to S1001 to S1006 and S1008 of FIG. 10, the description thereof is omitted.

### Operation Screen

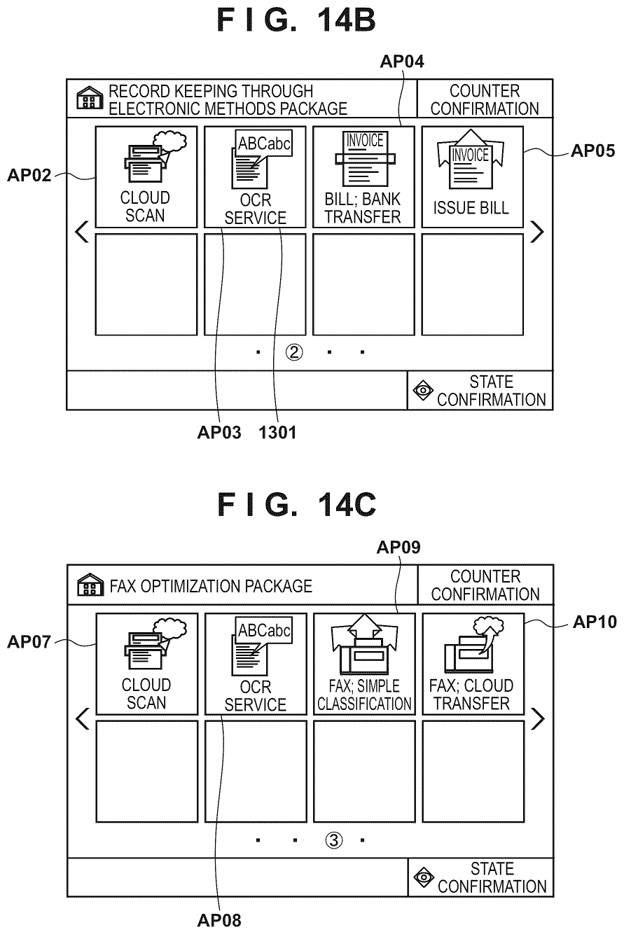

The arrangement of the operation icons on the operation screen of the image forming apparatus 100 according to the present embodiment will be described with reference to FIGS. 14A to C. FIGS. 14A to C illustrate screen examples in the case where of arranging the common app by default. In the first embodiment described above, as illustrated in FIGS. 13A to C, the dashboard apps are arranged on the respective package screens (FIGS. 13B to C).

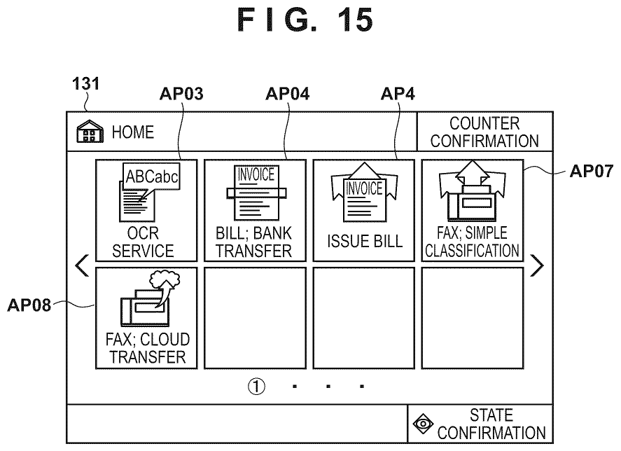

On the other hand, according to the present embodiment, as illustrated in FIG. 14A, the dashboard app that is the common app is arranged on the default screen (FIG. 14A). This can secure an area of the screen (FIGS. 14B and C) of each package. Note that FIG. 15 illustrates an example of putting together all common apps among packages. In this case, it is necessary to select the packaging setting after app activation, which is troublesome for the user. Therefore, the app displaying the icon on the default screen as the common app is desirably an app that is commonly available in settings and the like.

As described above, in a case where there is a common application among a plurality of packages, the information processing apparatus according to the present embodiment does not arrange an operation icon corresponding to the common application and arranges an operation icon common to a default operation screen. Thus, according to the present embodiment, the applications commonly used in all packages are arranged on the default screen as a common icon. This eliminates the need of confirmation of the setting content of the app installed in each package.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-076090, filed May 8, 2024, which is hereby incorporated by reference herein in its entirety.

What is claimed is:

1. An information processing apparatus comprising:
one or more memory devices that store a set of instructions; and
one or more processors that execute the set of instructions to:
acquire, from a server, an application group corresponding to an available service;
determine whether or not the acquired application group includes a package including a plurality of applications; and
generate an operation screen on which operation icons respectively corresponding to the plurality of applications are collectively arranged for each package in a case where the application group includes the package in accordance with a result of the determining.

2. The information processing apparatus according to claim 1, wherein
the one or more processors execute instructions in the one or more memory devices to: generate a different screen for each package and arrange a corresponding operation icon.

3. The information processing apparatus according to claim 2, wherein
the one or more processors execute instructions in the one or more memory devices to: install a package in the application group for each package, and reflect a setting dedicated to the package in each application.

4. The information processing apparatus according to claim 2, wherein
information identifying the package is displayed on the different screen for each package.

5. The information processing apparatus according to claim 2, wherein
the different screen for each package is displayed in a background color identifying the package.

6. The information processing apparatus according to claim 2, wherein
in a case where there is a common application among a plurality of packages, an operation icon corresponding to the common application is not arranged on the different screen for each package, and an operation icon common to a default operation screen is arranged.

7. The information processing apparatus according to claim 6, wherein
in a case where the common application among a plurality of packages requires a dedicated setting for each package, an operation icon corresponding to a different screen is arranged for each package, and in a case where the common application among a plurality of packages does not require a dedicated setting for each package, an operation icon corresponding to a different screen is not arranged for each package.

8. The information processing apparatus according to claim 2, wherein
an additional screen is generated and operation icons are arranged in a case where a number of operation icons corresponding to a plurality of applications included in a package is larger than a number of operation icons that can be arranged on the different screen.

9. The information processing apparatus according to claim 2, wherein
an operation icon arranged on the different screen is restricted from moving to another screen.

10. The information processing apparatus according to claim 2, wherein
duplication of an operation icon arranged on the different screen is generated when the operation icon moves to another screen, and is maintained on the different screen.

11. The information processing apparatus according to claim 3, wherein
a plurality of applications included in the package are collectively uninstalled.

12. The information processing apparatus according to claim 3, wherein
in a case where a plurality of applications included in the package are uninstalled, an application that is not uninstalled can be designated.

13. The information processing apparatus according to claim 2, wherein
the different screen is managed by a page, a tab, or a folder.

14. A control method for an information processing apparatus, the control method comprising:
acquiring, from a server, an application group corresponding to an available service;
determining whether or not the acquired application group includes a package including a plurality of applications; and
generating an operation screen on which operation icons respectively corresponding to the plurality of applications are collectively arranged for each package in a case where the application group includes the package in accordance with a result of the determining.

15. A non-transitory computer-readable storage medium storing a computer program for causing a computer to execute each process in a control method for an information processing apparatus, the control method comprising:
acquiring, from a server, an application group corresponding to an available service;
determining whether or not the acquired application group includes a package including a plurality of applications; and
generating an operation screen on which operation icons respectively corresponding to the plurality of applications are collectively arranged for each package in a case where the application group includes the package in accordance with a result of the determining.
